(19) United States
(12) Patent Application Publication
(10) Pub. No.: US 2021/0223364 A1
(43) Pub. Date: Jul. 22, 2021

(54) ESTIMATION DEVICE, OBJECT CONVEYANCE SYSTEM, ESTIMATION METHOD, AND PROGRAM

(71) Applicant: Kabushiki Kaisha Toshiba, Tokyo (JP)

(72) Inventors: Tenta SASAYA, Ota (JP); Toshiyuki ONO, Kawasaki (JP); Wataru WATANABE, Koto (JP)

(73) Assignee: Kabushiki Kaisha Toshiba, Tokyo (JP)

(21) Appl. No.: 17/010,986

(22) Filed: Sep. 3, 2020

(30) Foreign Application Priority Data
Jan. 20, 2020 (JP) 2020-006887

(51) Int. Cl. G01S 7/48; G01S 17/02; G01S 7/4861; G01S 7/484; G01S 7/4865

(52) U.S. Cl. CPC G01S 7/4808; G01S 17/02; G01S 7/4866; G01S 7/484; G01S 7/4861

(57) ABSTRACT

An estimation device includes a controller and an estimator. The estimation device switches a plurality of control conditions which are set so that there is satisfied at least one of conditions that that irradiation patterns of irradiation light radiated to an object are different from each other under the plurality of control conditions, and that light receiving patterns to receive reflected light obtained by reflecting the irradiation light by the object are different from each other under the plurality of control conditions; and estimates characteristics of the object on the basis of object data related to the object acquired by receiving light from one or more light receiving gates under the plurality of control conditions.

### BACKGROUND

### Technical Field

Embodiments of the present invention generally relate to an estimation device, an object conveyance system, an estimation method, and a program.

### Related Art

In the related art, a distance from an object is measured by irradiating the object with light pulses and measuring a time difference between a time when the light pulses are irradiated and a time when the radiated light pulses detect the reflected light reflected by the object. This technology is a technology of measuring a distance from an object using a flight time of light pulses, which is referred to as time-of-flight (ToF). The time-of-flight technology is put to practical use, for example, in a camera configured to measure a distance from an object (hereinafter, referred to as a “ToF camera”).

Incidentally, one of challenges in measuring a distance using the ToF technology is that a measured distance varies depending on a material of an object of a measurement target. For example, when a paper label is pasted on a translucent plastic container that contains contents such as a liquid, a solid (including a semi-solid), or the like, while it is necessary to measure the same distance assuming that the plastic container and the paper label are disposed at the same position, it may happen that the measured distance differs between the plastic container and the paper label. This is because there is a time difference between the plastic container and the paper label before the irradiated light pulse is reflected by the surface of the object and returns as reflected light. More specifically, in the translucent plastic container, scattering of the light occurs when the light pulse is reflected between the plastic container and the contained contents, and this scattering of the light causes a time difference between the time for detecting the reflected light from the paper label and the time for detecting the reflected light from the plastic container. In addition, since this scattering of the light varies depending on the color of the object or the like, even when the objects formed of the same material are disposed at the same position, the measured distances may be different due to the difference in color.

In this regard, a technology related to a method of reducing a difference in measured distance generated due to a material of an object is disclosed.

### PATENT DOCUMENTS

### [Non-Patent Document 1]

Shuochen Su, Felix Heide, Robin Swanson, Jonathan Klein, Clara Callenberg, Matthias Hullin, Wolfgang Heidrich, “Material Classification Using Raw Time-of-Flight Measurements,” IEEE Conference on Computer Vision and Pattern Recognition (CVPR), 2016, p. 3503 to 3511

### [Non-Patent Document 2]

Yuya Iwaguchi, Kenichiro Tanaka, Takahito Aoto, Hiroyuki Kubo, Takuya Funatomi, Yasuhiro Mukaigawa, “Classification of Translucent Objects using Distance Measurement Distortion of ToF Camera as Clue,” Information Processing Conference Technical Report (IPSJ SIG Technical Report), Vol. 2016-CVIM-203 No. 12, p. 1 to 7, Sep. 5, 2016

### [Non-Patent Document 3]

Kenichiro Tanaka, Yasuhiro Mukaigawa, Takuya Funatomi, Hiroyuki Kubo, Yasuyuki Matsushita, Yasushi Yagi, “Material Classification using Frequency- and Depth-Dependent Time-of-Flight Distortion,” IEEE Conference on Computer Vision and Pattern Recognition (CVPR), 2017, p. 79 to 88

However, in a general ToF camera, nothing can change modulation frequency or phase delay amount of irradiated light pulses. For this reason, it is necessary to improve the ToF camera that is currently being implemented, and conventional technologies cannot be easily applied. In addition, even in the general ToF camera, while it is considered that a distance between the ToF camera and the object can be changed, for example, the distance may not be easily changed due to spatial limitation or the like.

### SUMMARY

According to some embodiments, an estimation device, an object conveyance system, an estimation method, and a program are to estimate characteristics of an object by performing measurement through an easy method.

An estimation device of an embodiment includes: a controller configured to switch a plurality of control conditions which are set so that there is satisfied at least one of conditions that that irradiation patterns of irradiation light radiated to an object are different from each other under the plurality of control conditions, and that light receiving patterns to receive reflected light obtained by reflecting the irradiation light by the object are different from each other under the plurality of control conditions; and an estimator configured to estimate characteristics of the object on the basis of object data related to the object acquired by receiving light through one or more light receiving gates under the plurality of control conditions.

### BRIEF DESCRIPTION OF THE DRAWINGS

FIG. 1 is a block diagram showing an example of a configuration of an estimation device of a first embodiment.

FIG. 2 is a view for describing an irradiation pattern and a light receiving pattern set by a controller.

FIG. 3 is a view for describing a method of creating a table stored in a storage.

FIG. 4 is a flowchart showing a flow of an estimation operation of the estimation device of the first embodiment.

FIG. 5 is a block diagram showing an example of a configuration of an estimation device of a second embodiment.

FIG. 6 is a flowchart showing a flow of an estimation operation of the estimation device of the second embodiment.

FIG. 7 is a block diagram showing an example of a configuration of an estimation device of a third embodiment.

FIG. 8 is a view showing an example of image processing of generating a feature image in an image processor.

FIG. 9 is a view schematically showing an example of a configuration of an object conveyance system that employs an estimation device.

### DETAILED DESCRIPTION OF THE INVENTION

Hereinafter, an estimation device, an object conveyance system, an estimation method, and a program of embodiments will be described with reference to the accompanying drawings.

### First Embodiment

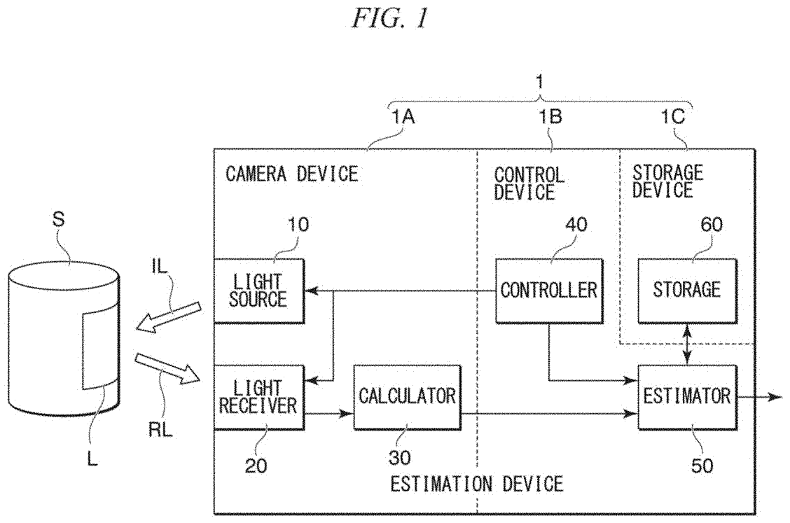

FIG. 1 is a block diagram showing an example of a configuration of an estimation device of a first embodiment. An estimation device 1 includes, for example, a light source 10, a light receiver 20, a calculator 30, a controller 40, an estimator 50 and a storage 60.

In addition, part or all of the calculator 30, the controller 40 and the estimator 50 included in the estimation device 1 are realized by executing a program (software) using a hardware processor such as a central processing unit (CPU) or the like. In addition, part or all of these components may be realized by hardware (a circuit; including circuitry) such as large scale integration (LSI), an application specific integrated circuit (ASIC), a field-programmable gate array (FPGA), a graphics processing unit (GPU), or the like, or may be realized by cooperation of software and hardware. In addition, part or all of functions of these components may be realized by a dedicated LSI. The program (software) may be previously stored in a storage device (a storage device including a non-transient storage medium) such as a hard disk drive (HDD), a flash memory, or the like, stored in a detachable storage medium (a non-transient storage medium) such as a DVD, a CD-ROM, or the like, or installed in the storage device by mounting the storage medium in a drive device. In addition, the program (software) may be previously downloaded via a network from another computer device and installed in the storage device.

Further, in FIG. 1, while an example in which these components are collectively configured as the estimation device 1 is shown, this is only an example and part or all of these components in the estimation device 1 may be distributedly arranged. For example, the light source 10, the light receiver 20 and the calculator 30 may be collectively configured as a camera device 1A, the controller 40 and the estimator 50 may be collectively configured as a control device 1B, and the storage 60 may be configured as a storage device 1C. Further, for example, the camera device 1A may be separated, and the control device 1B and the storage device 1C may be arranged integrally. In the following description, an example in which these components included in the estimation device 1 are functionally collected and the camera device 1A, the control device 1B and the storage device 1C are configured separately will be exemplarily described.

The camera device 1A is a ToF camera configured to measure a distance between the ToF camera and the object using a time-of-flight (ToF) technology. FIG. 1 also shows an object S that is a target whose characteristics are to be estimated by the estimation device 1 and configured to measure a disposed distance using the camera device 1A. The object S shown in FIG. 1 is a translucent plastic container that contains contents such as a liquid, a solid (including a semi-solid), or the like, and an object having a surface of the plastic container on which a paper label L is pasted. Further, a material of the object S is not limited to plastic, and for example, may be any material, for example, a paper such as a corrugated board or the like, vinyl, metal, fabric, or the like. In addition, similarly, the material of the label L may also be any material.

The light source 10 radiates irradiation light IL to a space in which the object S as the target whose characteristics are to be estimated by the estimation device 1 is present. The irradiation light IL is, for example, light having a near-infrared wavelength bandwidth. The light source 10 is a light emitting module such as a light emitting diode (LED). The light source 10 may be a surface emitting type semiconductor laser module such as a vertical cavity surface emitting laser (VCSEL) or the like. The light source 10 radiates pulse-shaped light (hereinafter, referred to as an “irradiation pulse”) as the irradiation light IL according to control conditions (to be described below) set by the controller 40. The light source 10 may diffuse and radiate light emitted from a light emitting module to a surface having a predetermined width in a space in which the object S whose characteristics are to be estimated is present using, for example, a diffusion plate (not shown).

First, the light source 10 may be one that can change a wavelength bandwidth of the irradiation light IL. In this case, the light source 10 radiates the irradiation light IL having a wavelength bandwidth according to control conditions (to be described below) set by the controller 40.

The light receiver 20 receives reflected light RL obtained by reflecting an irradiation pulse of the irradiation light IL radiated from the light source 10 on the object S, and outputs data (hereinafter, referred to as “light reception data”) indicating a quantity of light of the reflected light RL that was received. The light receiver 20 is, for example, a distance image sensor (hereinafter, referred to as a “ToF sensor”) in which a pixel configured to receive the reflected light RL includes at least one light receiving gate to measure a distance of one place. In the light receiver 20, for example, a plurality of pixels may be disposed in a two-dimensional matrix form. For example, the light receiver 20 may receive the reflected light RL collected by an optical lens (not shown) configured to guide incidence light to the light receiver 20. The light receiver 20 receives the reflected light RL that is entering through light receiving gates at a timing according to the control conditions (to be described below) set by the controller 40, and outputs light reception data representing a quantity of light of the reflected light RL received through the light receiving gates to the calculator 30.

The calculator 30 acquires the light reception data from the light receiving gates output by the light receiver 20. The calculator 30 obtains data related to a distance between the camera device 1A and the object S and outputs the obtained data (hereinafter, referred to as “object data”) to the estimator 50 on the basis of the acquired light reception data. More specifically, the calculator 30 calculates a distance between the camera device 1A and the target object S whose characteristics are to be estimated in the estimation device 1 by performing four arithmetic operations on the obtained light reception data. The calculator 30 outputs object data indicating a value of the calculated distance between the camera device 1A and the object S (hereinafter, referred to as a “distance value”) to the estimator 50.

The control device 1B controls an irradiation timing of the irradiation light IL by the light source 10 included in the camera device 1A, and a light reception timing of the reflected light RL in the light receiving gates included in the light receiver 20. The control device 1B estimates characteristics of the object S on the basis of object data (distance value) output by the calculator 30 included in the camera device 1A.

The controller 40 sets setting of control conditions when characteristics of the object S are estimated in the estimation device 1. The controller 40 sets control conditions of the irradiation pulse on the light source 10 when the camera device 1A radiates the irradiation light IL to the object S, and sets control conditions of the light receiving gates on the light receiver 20 when the camera device 1A receives the reflected light RL. In the controller 40, a plurality of predetermined patterns related to the irradiation pulse to change the irradiation timing of the irradiation light IL (hereinafter, referred to as a “irradiation pattern”) and a plurality of predetermined patterns related to the gate pulse to change the light reception timing of the reflected light RL in the light receiving gates (hereinafter, referred to as a “light receiving pattern”) are previously set (registered).

The controller 40 sets the control conditions in which the irradiation patterns and the light receiving patterns, which are preset, are combined so that at least one type patterns differ from each other under the plurality of control conditions, on the light source 10 and the light receiver 20 included in the camera device 1A. The irradiation pattern and the light receiving pattern are combined such that a quantity of light of the reflected light RL indicating the light reception data differs even when the camera device 1A receives the reflected light RL reflected by the object S in the same state. For this reason, there is only one combination of the irradiation pattern and the light receiving pattern in which the reflected light RL represented by the light reception data has the same quantity of light. In the estimation device 1, characteristics of the object S are estimated as the controller 40 switches the control conditions a plurality of times. For this reason, the controller 40 sets the conditions in which combination of the irradiation pattern and the light receiving pattern is changed a plurality of times when the characteristics of the object S are estimated in the estimation device 1. The controller 40 outputs information of the control conditions (combination of the irradiation pattern and the light receiving pattern) set on the light source 10 and the light receiver 20 to the estimator 50.

The estimator 50 estimates the characteristics of the object S on the basis of the information of the control conditions set on the light source 10 and the light receiver 20 by the controller 40 and distance values d represented by the object data output by the calculator 30. For example, the estimator 50 estimates the distance values d represented by the object data output by the calculator 30, and estimates the distance between the camera device 1A and the object S. In addition, for example, the estimator 50 estimates the material of the object S on the basis of the distance values d represented by the object data output by the calculator 30. In addition, for example, the estimator 50 estimates attributes of the object S on the basis of the distance values d represented by the object data output by the calculator 30. For example, the attributes of the object S are information representing at least one of a reflection factor, a refractive index, a transmission factor, an attenuation coefficient, an absorption coefficient, a scattering cross-sectional area, a dielectric constant, a density, and a concentration of the object S.

The estimator 50 refers characteristics data (to be described below) stored in the storage 60 when the characteristics of the object S are estimated. More specifically, the estimator 50 estimates the characteristics of the object S by selecting the characteristics data corresponding to the control conditions set by the controller 40 and comparing the distance values d output by the calculator 30 with the selected characteristics data. The estimator 50 outputs the estimated distance between the camera device 1A and the object S, the material of the object S or the attributes of the object S as the estimated data (hereinafter, referred to as a “estimation data”) of the characteristics of the object S. In the following description, when the estimation data estimated by the estimator 50 are distinguished, the estimation data representing the distance between the camera device 1A and the object S is referred to as “an estimation distance D,” the estimation data representing the material of the object S is referred to as “an estimation material M” and the estimation data representing the attributes of the object S is referred to as “estimation attributes A.”

The storage device 1C stores characteristics data used when the estimator 50 included in the control device 1B estimates the characteristics of the object S in the storage 60. The storage 60 is a storage device (a storage device including a non-transient storage medium) configured to store characteristics data such as a hard disk drive (HDD), a flash memory, or the like. Further, the characteristics data are stored in a detachable storage medium (a non-transient storage medium) such as a DVD, a CD-ROM, or the like, and may be referred by the estimator 50 by being mounted on the drive device included in the storage 60. In addition, the characteristics data may be previously downloaded via a network from another computer device and stored in the storage 60.

The characteristics data are, for example, a table in which correspondences between the control conditions and characteristics of an arbitrary object are determined. The table is created by actually measuring an object assumed as the object S before the estimation device 1 is started to be practically used. For crating the table, measurement of the object assumed as the object S may be performed under an environment in which a test is performed, for example, a laboratory or the like. For example, the object assumed as the object S is actually disposed within a range in which the distance between the camera device 1A and the object S is estimated in the estimation device 1, and the distance values d obtained by the calculator 30 are collected to correspond to the control conditions (combination of the irradiation pattern and the light receiving pattern) set on the light source 10 or the light receiver 20 by the controller 40 while changing the position of the object within a predetermined distance width. That is, the distance values d of the plurality of control conditions are collected while changing an actual distance between the camera device 1A and the object assumed as the object S within the predetermined distance width in an estimative range of the distance between the camera device 1A and the object S in the estimation device 1. For example, when the estimative range of the distance between the camera device 1A and the object S in the estimation device 1 is 100 [cm], the position of the object assumed as the object S is moved in steps of several [cm], the control conditions at each position are changed a plurality of times (for example, about tens of times), and the distance values d under each of the control conditions are collected. In this case, for example, hundreds of the distance values d will be collected.

As the object assumed as the object S disposed at the predetermined distance to collect the distance values d, for example, the object formed of the same material and having the same color or the like as the object S estimated in the estimation device 1 is used. Then, the table corresponding to the object used in the measurement is created using the plurality of distance values d collected with respect to the same object as the data. In addition, a table corresponding to another object is created by changing the material (for example, a paper, plastic, vinyl, a metal, fabric, or the like) or color of the object to different ones and collecting the distance values d similarly obtained by the calculator 30 to correspond to the control conditions. In this way, a plurality of tables configured to more accurately derive the estimation distance D, the estimation material M and the estimation attributes A of the target object S estimated in the estimation device 1 are created on the estimated characteristics such as the material, the color, or the like of the target object S. The plurality of tables created in this way and corresponding to the object formed of different materials or having different colors are stored in the storage 60.

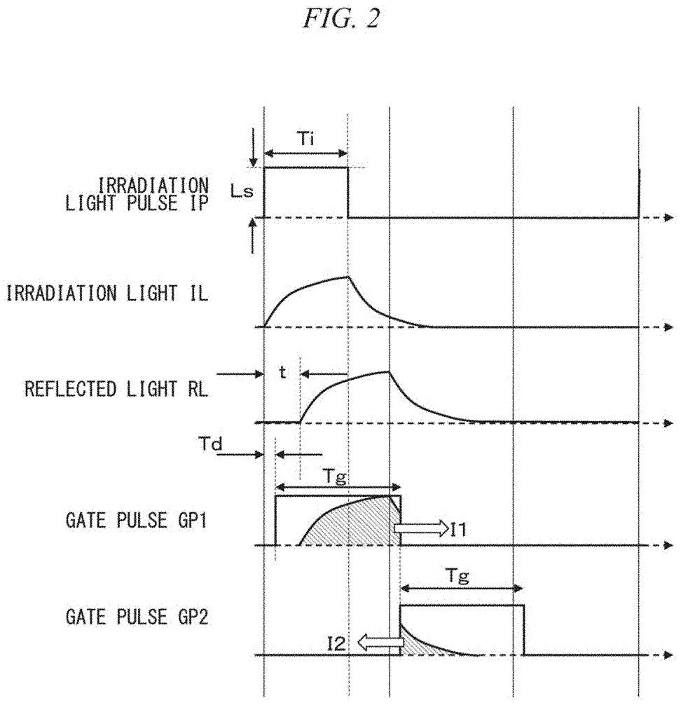

Next, an example of irradiation patterns and light receiving patterns set on the camera device 1A by the controller 40 will be described. FIG. 2 is a view for describing the irradiation patterns and the light receiving patterns set in the controller 40. The example shown in FIG. 2 is an example in the case of the configuration in which a pixel of the light receiver 20 includes two light receiving gates configured to receive the reflected light RL (hereinafter, each of the light receiving gates is distinguished into “a light receiving gate G1” and “a light receiving gate G2”). FIG. 2 shows an example of changes over time in an irradiation pulse IP set on the light source 10 by the controller 40, the irradiation light IL radiated from the light source 10 according to the irradiation pulse IP, the reflected light RL that is the irradiation light IL reflected by the object S and entering the light receiver 20, a gate pulse GP1 set on the light receiving gate G1 of the light receiver 20 by the controller 40, and a gate pulse GP2 set on the light receiving gate G2. In FIG. 2, a horizontal axis is time. In addition, in FIG. 2, longitudinal axes of the irradiation pulse IP, the gate pulse GP1 and the gate pulse GP2 are signal levels of the pulses, and longitudinal axes of the irradiation light IL and the reflected light RL are intensities of light (light intensities) thereof. Further, in the following description, the light receiving gate G1 and the light receiving gate G2 are referred as “a light receiving gate G” when they are not distinguished, and the gate pulse GP1 and the gate pulse GP2 are referred to as “a gate pulse GP” when they are not distinguished.

The irradiation pattern is determined in a pulse shape obtained by combining a pulse length Ti of the irradiation pulse IP representing an irradiation time of the irradiation light IL and a signal level Ls of the irradiation pulse IP representing an intensity (a light intensity) of the irradiation light IL. In the controller 40, the plurality of irradiation patterns are set in advance so that there is satisfied at least one of conditions that the pulse lengths Ti differ from each other and the signal levels Ls differ from each other.

Further, the irradiation patterns are the same as the parameter prepared in advance that can be changed even in a general ToF camera, or can be set using the parameter prepared in advance.

The light source 10 radiates the irradiation light IL that reproduces the pulse length Ti and the signal level Ls of the irradiation pulse IP determined in the irradiation patterns set as the control conditions. Further, an ideal pulse shape of the irradiation light IL is the same rectangular shape as the irradiation pulse IP determined as the irradiation patterns. However, light emission in the light emitting module that constitutes the light source 10 is not particularly limited to the same rectangular shape as the irradiation pulse IP. This is because a predetermined transition time is required from a build-up (emission start) or falling (emission finish) timing represented by the irradiation pulse IP to a state (an emission state or an extinction state) actually represented by the irradiation pulse IP in the light actually emitted from the light emitting module. For this reason, the quantity of the reflected light RL obtained by reflecting the irradiation light IL on the object S and entering the light receiver 20 also includes the same temporal transition as the irradiation light IL.

FIG. 2 shows an example of temporal transition of the quantity of the irradiation light IL radiated from the light source 10 according to the irradiation pulse IP. In addition, FIG. 2 shows an example of temporal transition of the quantity of the reflected light RL. Further, in the example of the reflected light RL shown in FIG. 2, while the case in which the irradiation light IL is entirely reflected by the object S to return as the reflected light RL has been shown, even when scattering of the irradiation light IL occurs in the object S, the irradiation light IL that was radiated does not return as the reflected light RL as a whole, and the quantity or the pulse shape of the reflected light RL is different from the irradiation light IL. Further, the time difference t between the irradiation light IL and the reflected light RL is due to the distance between the camera device 1A and the object S.

Further, when a wavelength bandwidth of the irradiation light IL radiated from the light source 10 can be changed, the wavelength bandwidth of the irradiation light IL in the irradiation patterns may be determined in advance. In addition, in FIG. 2, while the case in which the irradiation pulse IP is one rectangular pulse has been shown, the irradiation pulse IP may have a shape in which a plurality of rectangular pulses having different pulse lengths Ti or signal levels Ls (may include wavelength bandwidths of the irradiation light IL) are continuous with each other.

The light receiving pattern is determined in combination with a pulse length Tg of the gate pulse GP representing a light reception time when the light receiving gates G configured to receive the reflected light RL that is entering receive the reflected light RL and a relative time difference Td from the irradiation pulse IP in the gate pulse GP. The pulse length Tg of the gate pulse GP is a response time related to sensitivity of the light receiving gates G. In addition, the relative time difference Td of the gate pulse GP is a delay time from a start time (a build-up timing) of the irradiation pulse IP to a start time (a build-up timing) of the gate pulse GP. In the controller 40, a plurality of light receiving patterns are set in advance so that at least one of the pulse length Tg of the gate pulse and the relative time difference Td differs.

Further, the light receiving pattern is determined for each of the light receiving gates G included in the light receiver 20. Here, the relative time difference Td may set the same time determined with respect to the gate pulse GP (in FIG. 2, the gate pulse GP1) that is earlier in time as the finish time of the gate pulse GP (the gate pulse GP1) as a relative time difference corresponding to the gate pulse GP2, i.e., a delay time from the start time (the build-up timing) of the irradiation pulse IP to the start time (the build-up timing) of the gate pulse GP (in FIG. 2, the gate pulse GP2) that is later in time. In addition, the pulse length Tg may be the same pulse length Tg in the gate pulse GP1 and the gate pulse GP2.

In addition, in FIG. 2, while the case in which each gate pulse GP in the light receiving pattern is one rectangular pulse has been shown, the gate pulse GP may have a shape in which a plurality of rectangular pulses having different pulse lengths Tg or signal levels are continuous. In this case, it is possible to perform weighted processing according to the light reception time of the reflected light RL in each of the light receiving gates G.

Further, the light receiving patterns are the same as the parameter prepared in advance as a parameter that can be changed in the general ToF camera, or can be set using a parameter prepared in advance.

A pixel of the light receiver 20 receives the reflected light RL that is entering during a period in which the pulse length Tg and the relative time difference Td of each of the light receiving gates G determined in the light receiving patterns set as the control conditions are reproduced. Then, each of the light receiving gates G outputs the light reception data representing the quantity of the reflected light RL that was received to the calculator 30. The light reception data is, for example, an amount of charges that charges generated according to the quantity of the reflected light RL received through the light receiving gates G are stored (integrated). FIG. 2 shows a state in which the light receiving gate G1 outputs light reception data of integrated charges I1 that are generated and integrated during the period of the gate pulse GP1 and the light receiving gate G2 outputs light reception data of integrated charges I2 that are generated and integrated during the period of the gate pulse GP2.

The calculator 30 obtains one distance value between the camera device 1A and the object S by four arithmetic operations on light reception data from each of the light receiving gate G output by the light receiver 20. Here, first, the calculator 30 substitutes the integrated charges I1, the integrated charges I2, and the pulse length Ti of the irradiation pulse IP into the following equation (1) and obtains a time difference t between the irradiation light IL and the reflected light RL.

$$\begin{matrix}[ Math . 1 ] & \\ t = \frac{I 2}{I 1 + I 2} Ti & ( 1 )\end{matrix}$$

After that, the calculator 30 substitutes the time difference t obtained by the above-mentioned equation (1) and a light velocity c into the following equation (2) and obtains the distance values d between the camera device 1A and the object S.

$$\begin{matrix}[ Math . 2 ] & \\ d = \frac{tc}{2} & ( 2 )\end{matrix}$$

Further, the pixel of the light receiver 20 is also configured to include a light receiving gate (hereinafter, referred to as a “the light receiving gate GB”) configured to receive light of an environment (environmental light) under which characteristics of the object S are estimated in the estimation device 1, in addition to the light receiving gate G configured to receive the reflected light RL. In this case, the calculator 30 can obtain the time difference tin a state in which influence of the environmental light is reduced using the following equation (3) instead of the above-mentioned equation (1).

$$\begin{matrix}[ Math . 3 ] & \\ t = \frac{I 2 - IB}{I 1 + I 2 - 2 IB} Ti & ( 3 )\end{matrix}$$

In the above-mentioned equation (3), IB designates integrated charges that are generated and integrated during the period of the gate pulse GPB after the gate pulse GP2 through the light receiving gate GB. Further, the pulse length Tg of the gate pulse GPB and the relative time difference Td are also predetermined by the light receiving pattern in advance. Here, the pulse length Tg of the gate pulse GPB and the relative time difference Td may also be determined on the basis of the relationship with the gate pulse GP2, similar to the pulse length Tg of the gate pulse GP2 and the relative time difference Td.

The calculator 30 outputs the object data representing the distance values d obtained by the above-mentioned equation (2) to the estimator 50.

Further, in the estimation device 1, when the characteristics of the object S are estimated, the controller 40 switches the control conditions set on the light source 10 and the light receiver 20 a plurality of times. That is, in the estimation device 1, when the characteristics of the object S are estimated one time, the calculator 30 acquires a plurality of light reception data output through the light receiving gates G as the controller 40 switches the irradiation patterns or the light receiving patterns a plurality of times. For this reason, the calculator 30 may obtain the object data on the basis of part or all of the acquired plurality of light reception data, or a multi-dimensional vector using two or more light reception data as elements. More specifically, the calculator 30 may perform four arithmetic operations on a multi-dimensional vector using a plurality of integrated charges I as elements corresponding to the integrated charges I1 and the integrated charges I2 and obtain the distance values d. Here, a multi-dimensional vector v_{I1} corresponding to the integrated charges I1 is represented by, for example, the following equation (4).

[Math. 4]

v_{I1}=(I₁¹,I₁², . . . ,I₁ⁿ) (4)

In the above-mentioned equation (4), a lower right number of each element of the multi-dimensional vector v_{I1} means the integrated charges I1, and an upper right number of each element means an identification number that identifies control conditions (irradiation patterns or light receiving patterns). Further, the identification number=n means the total number of control conditions, i.e., that the controller 40 switches the control conditions n times in the estimation of the characteristics of the object S of one time in the estimation device 1.

Further, for example, the multi-dimensional vector may be represented by the time difference t representing correlation of the distance values d as in the following equation (5).

[Math. 5]

vₜ=(t¹,t², . . . ,tⁿ) (5)

In the above-mentioned equation (5), an upper right number of each element of the multi-dimensional vector vₜ means an identification number that identifies the control conditions, like the above-mentioned equation (4).

In addition, for example, the multi-dimensional vector may be combination of the multi-dimensional vector v_{I1} represented by the above-mentioned equation (4) and the multi-dimensional vector vₜ represented by the above-mentioned equation (5), like the following equation (6).

[Math. 6]

v_{I1t}=(I₁¹,t¹,I₁²,t², . . . ,I₁ⁿ,tⁿ) (6)

In the above-mentioned equation (6), meanings of the lower right number and the upper right number of each element of the multi-dimensional vector v_{I1t} are the same as the above-mentioned equation (4).

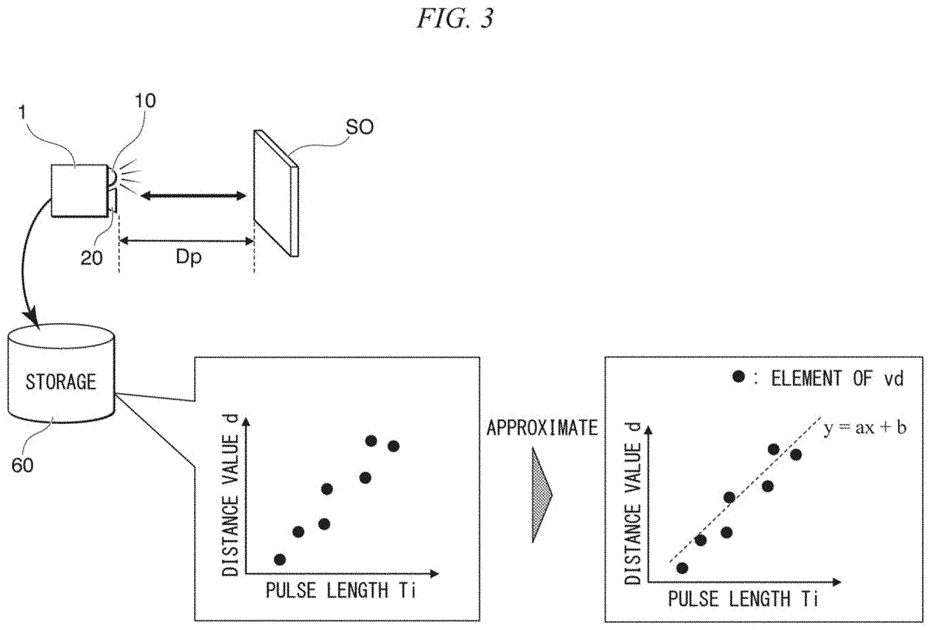

Next, an example of a method of creating characteristics data (table) stored in the storage 60 will be described. FIG. 3 is a view for describing a method of creating a table stored in the storage 60. FIG. 3 shows an example in the case in which a table for estimating the estimation distance D between the camera device 1A and the object S is created on the basis of the pulse length Ti as the control conditions and the distance values d obtained by the calculator 30.

When the characteristics data (table) are created, a measurement object SO assumed as the object S is disposed at a position in the estimative range between the camera device 1A and the object S from the estimation device 1, predetermined control conditions are set by the controller 40, and the distance values d are measured. FIG. 3 shows a state in which the measurement object SO is disposed at a position separated from the estimation device 1 by a distance Dp and the distance values d are measured. Further, in a state in which the measurement object SO is disposed at the same position, setting of the control conditions is changed by the controller 40, and the distance values d are measured similarly. Measurement of the distance values d at which the control conditions are changed in a state in which the measurement object SO is disposed at the same position is repeated by a predetermined number of times, and the distance values d are collected. Here, the number of the distance values d collected when the table is created, i.e., the number of times to change the control conditions is the same as the number of combinations of the irradiation patterns and the light receiving patterns, in which the integrated charges I output by receiving the reflected light RL from the measurement object SO disposed at the same position through the light receiving gates G are different.

Further, the combinations of the irradiation patterns and the light receiving patterns may be the same as the number of combinations of the irradiation patterns and the light receiving patterns changed (switched) by the controller 40 to estimate the characteristics of one object S when the estimation device 1 is practically used. Further, while the distance values d collected herein have different control conditions, the distance between the estimation device 1 and the measurement object SO represents the same distance. For example, the distance values d collected in a state in which the measurement object SO is disposed at a position separated from the estimation device 1 by 30 [cm] represents that the distance between the estimation device 1 and the measurement object SO is 30 [cm] even when the control conditions are different. However, for example, differences in the distance values d due to differences in control conditions such as a measurement error appear. In order to reduce (correct) the difference in the distance values d due to the difference in control conditions, the distance values d for creating the table under each of the control conditions are collected.

After that, the position at which the measurement object SO is disposed is changed by a predetermined distance width and the distance values d are collected similarly. A collecting work of the distance values d is repeated while sequentially changing the position where the measurement object SO is disposed within the estimative range in the estimation device 1 with the predetermined distance width.

The distance values d configured to create the table are collected in this way. Further, the distance values d are collected by switching the control conditions set on the light source 10 and the light receiver 20 by the controller 40 a plurality of times. For this reason, part or all of the plurality of collected distance values d, or two or more distance values d can be represented as elements, for example, the multi-dimensional vector v_{d} as in the following equation (7).

[Math. 7]

v_{d}=(d¹,d², . . . ,dⁿ) (7)

In the above-mentioned equation (7), an upper right number of each element of the multi-dimensional vector v_{d} means an identification number that identifies control conditions (irradiation patterns or light receiving patterns). Further, the identification number=n means the total number of control conditions, i.e., that the controller 40 switches the control conditions n times when the distance values d for creating the table are collected.

The table is generated on the basis of the collected multi-dimensional vector v_{d}. In order to easily show the features of the table to be created, FIG. 3 shows an example of the table created in a form in which the distance values d that are elements of the multi-dimensional vector v_{d} are plotted on a graph in which a horizontal axis represents control conditions (here, the pulse length Ti) and a longitudinal axis represents the distance values d obtained by the calculator 30. In practical use of the estimation device 1, a value of the longitudinal axis in the graph shown in FIG. 3 is the estimation distance D.

Further, the characteristics data (table) may be a feature value (hereinafter, referred to as a “feature value \hat{ }v_{d}”) as in the following equation (9) represented by, for example, approximating the multi-dimensional vector v_{d} to the following equation (8) on the basis of the plotted elements of the multi-dimensional vector v_{d} like the graph on the right side in FIG. 3.

[Math. 8]

y=ax+b (8)

[Math. 9]

\hat{v}_{d}=(a,b) (9)

Further, an approximation formula for representing the multi-dimensional vector v_{d} by the feature value \hat{ }v_{d} is not limited to a one-dimensional approximation formula such as the above-mentioned equation (8), and for example, the multi-dimensional vector v_{d} may be approximated by a two-dimensional approximation formula. That is, this in not limited to collinear approximation and may be curve approximation.

Further, the feature value may be the following equation (10) obtained by combining the above-mentioned equation (9) and the integrated charges I received and output through the light receiving gate G.

[Math. 10]

\hat{v}_{dI}=(a,b,Ī₁) (10)

Here, a third element of the above-mentioned equation (10) on the right side is an element corresponding to the integrated charges I1, and represented by the following equation (11).

$$\begin{matrix}[ Math . 11 ] & \\ {\overline{I}}_{1} = \frac{1}{n} {\sum }_{1}^{n} {I}_{1}^{n} & ( 11 )\end{matrix}$$

In addition, the feature value may be the following equation (12) obtained by extracting one or more elements from the multi-dimensional vector v_{d} of the above-mentioned equation (7).

[Math. 12]

\hat{v}=(d¹,dⁿ) (12)

In addition, the feature value may be the following equation (13) as the difference between adjacent elements in the multi-dimensional vector v_{d} of the above-mentioned equation (7).

[Math. 13]

\hat{v}=(d¹−d²,d²−d³, . . . ,dⁿ⁻¹−dⁿ) (13)

In this way, a table corresponding to a type of the object S is created by collecting the distance values d obtained by actually measuring the measurement object SO assumed as the object S as the distance values d for creating the table while changing the distance (here, the distance Dp) between the estimation device 1 and the measurement object SO, and the control conditions set on the light source 10 and the light receiver 20 by the controller 40 a plurality of times. In addition, when a table corresponding to another type of the object S is created, after the measurement object SO is exchanged with an object formed of another type of material (for example, a paper, plastic, vinyl, a metal, fabric, or the like) or color, the distance values d are collected to create the table corresponding to the other type of the object S similarly.

The table created herein is a table corresponding to the material, color, or the like, of the assumed object S. For this reason, the estimator 50 in practical use of the estimation device 1 can refer the table stored in the storage 60, obtain characteristics of the object S in which an influence such as a material, color, or the like, is reduced, on the basis of the distance values d measured by practically using the estimation device 1, and output the characteristics as the estimation data. That is, the estimator 50 can output the estimation data in which characteristics are estimated as the same object and disposed at the same position, even when the reflected light RL received through the light receiving gates G is changed by the influence of the material or color, in the object constituted by combination of a plurality of materials or colors, on the basis of the distance values d measured by practically using the estimation device 1. In the object S shown in FIG. 1, in the estimator 50, the main body of the translucent plastic container that contains the contents such as a liquid, a solid (including semi-solid), or the like, and the paper label L adhered to the surface of the plastic container are belong to the same object S, and the estimation data obtained by estimating the characteristics can be output as being placed at the same position.

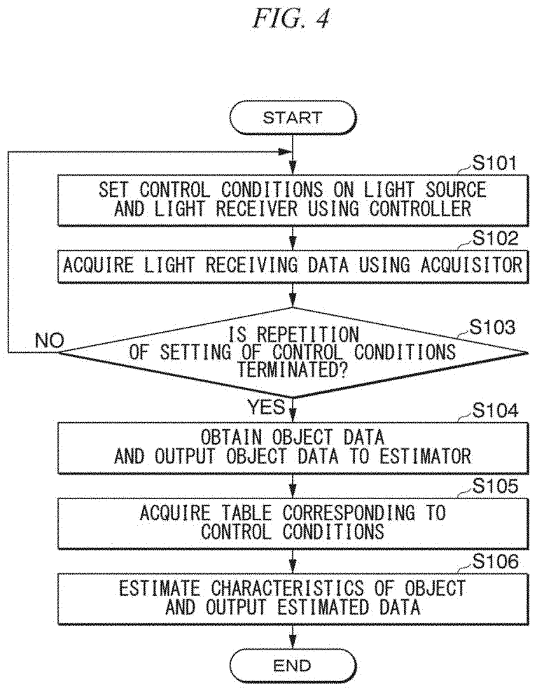

Next, an operation in practical use of the estimation device 1 will be described. FIG. 4 is a flowchart showing a flow of an estimation operation in the estimation device 1 of the first embodiment. Further, in the following description, it is assumed that the table used for estimating the characteristics of the object S using the estimator 50 is already stored in the storage 60. When the estimation device 1 is practically used, the controller 40 sets the same control conditions on the camera device 1A (i.e., repeated the same number of times) when the table is created, and the estimator 50 refers the table and estimates the characteristics of the object S on the basis of the object data output by the calculator 30. In the following description, the controller 40 switches the control conditions set on the camera device 1A n times, and the calculator 30 outputs the multi-dimensional vector in the same form as the multi-dimensional vector v_{d} represented by the above-mentioned equation (7) as the object data to the estimator 50.

When the estimation device 1 starts the operation of estimating the characteristics of the object S, the controller 40 sets initial control conditions (combination of irradiation patterns and light receiving patterns) on the light source 10 and the light receiver 20 included in the camera device 1A (step S101). Accordingly, the light source 10 radiates the irradiation lights IL to the object S according to the irradiation patterns set as the control conditions. In addition, the light receiver 20 outputs the light reception data representing the quantities of the reflected lights RL received through the light receiving gates G to the calculator 30 at a timing according to the light receiving patterns set as the control conditions.

Next, the calculator 30 acquires the light reception data from the light receiving gates G output by the light receiver 20 (step S102) Then, the calculator 30 obtains the object data (the distance values d) in the control conditions at this time on the basis of the acquired light reception data.

Next, the controller 40 determines whether setting of the control conditions on the light source 10 and the light receiver 20 has been repeated n times (step S103) In step S103, when setting of the control conditions has not been repeated n times, the controller 40 causes the processing to return to step S101, and sets the next control conditions (another combination of the irradiation pattern and the light receiving pattern).

Meanwhile, in step S103, when the setting of the control conditions has been repeated n times, for example, the controller 40 notifies the light source 10 and the light receiver 20 of that acquisition of the light reception data of the object S is terminated. Accordingly, the light source 10 terminates radiation of the irradiation light IL to the object S, and the light receiver 20 terminates reception of the reflected light RL in the light receiving gate G and output of the light reception data. In addition, the calculator 30 outputs the multi-dimensional vector of the n times of the object data obtained in the control conditions as the object data of the object S to the estimator 50 (step S104).

Next, the estimator 50 selects and acquires the corresponding table stored in the storage 60 on the basis of the information of the control conditions output by the controller 40 (step S105). Here, the estimator 50 may select a plurality of tables and acquire the tables from the storage 60. Then, the estimator 50 compares the data represented in the table acquired from the storage 60 with the distance values d of the control conditions represented by the object data (the multi-dimensional vector) output by the calculator 30, and estimates the characteristics of the object S. The estimator 50 outputs the estimation data of the characteristics of the object S that are estimated (step S106).

Here, an example of an estimation method of characteristics of the object S in the estimator 50 will be described. In the following description, the estimation distance D between the camera device 1A and the object S is estimated as the characteristics of the object S.

The estimator 50 sets the distance values d represented by the object data output by the calculator 30 as input of the table acquired from the storage 60. Then, the estimator 50 obtains similarity of the distance values d corresponding to the estimation distance D included in the table (the distance values d obtained by measuring the measurement object SO before practical use of the estimation device 1 is started: hereinafter, referred to as “table distance values dT”) and the distance values d represented by the object data that are input. The estimator 50 outputs the estimation data using the estimation distance D corresponding to one table distance value dT having the highest similarity as the distance between the object S and the camera device 1A, which is measured at this time, i.e., the distance between the object S and the estimation device 1.

Further, estimation of the characteristics of the object S in the estimator 50 is not limited to a method of setting data of the table having the highest similarity. The estimator 50 may output, for example, a value (here, the distance value) obtained by performing calculation by a category-weighting factor of a distance based on the similarity as the estimation data between the distance values d output by the calculator 30 that are input of the table and the plurality of (for example, two) table distance values dT included in the table. Calculation by the category-weighting factor is performed by, for example, the following equation (14).

$$\begin{matrix}[ Math . 14 ] & \\ {\sum }_{k}^{K} {r}_{k} \frac{{\sum }_{{k}^{′}}^{K} {s}_{{k}^{′}} - {s}_{k}}{{\sum }_{{k}^{′}}^{K} {s}_{{k}^{′}}} & ( 14 )\end{matrix}$$

In the above-mentioned equation (14), rₖ means a distance when k^{th} neighborhood data of the distance values d that are input is calculated, Sₖ means a distance (i e, similarity) between vectors with the distance values d and the k^{th} neighborhood data, which are input, and K means the number of pieces of data used for weighting calculation.

Further, the distance between vectors is, for example, a weighted sum of at least one of a BrayCurtis distance, a Canberra distance, a Chebyshev distance, a Manhattan distance (L1 norm), an Euclidean distance (L2 norm), a Mahalanobis distance, a Minkowski distance, a Wasserstein distance, a cosine similarity, and a histogram intersection.

The estimator 50 estimates the estimation distance D between the camera device 1A and the object S with reference to characteristics data (table) stored in the storage 60 through such processing.

As described above, in the estimation device 1 of the first embodiment, the controller 40 changes (switches) the control conditions (the irradiation patterns and the light receiving patterns) a plurality of times when the light source 10 and the light receiver 20 included in the camera device 1A are operated. Then, in the estimation device 1 of the first embodiment, the estimator 50 estimates the characteristics of the target object S on the basis of the object data output by the calculator 30 included in the camera device 1A with reference to the table previously stored in the storage 60. Accordingly, in the estimation device 1 of the first embodiment, it is possible to obtain a highly accurate measured result (or corrected result) related to the estimation of the characteristics of the target object S.

Moreover, in the control conditions in which the estimator 50 in the estimation device 1 of the first embodiment switches setting of the light source 10 and the light receiver 20 a plurality of times, a plurality of prepared parameter that can also be changed in the general ToF camera or patterns of the parameters that can be set using the prepared parameters are prepared as the irradiation pattern and the light receiving pattern. For this reason, in the estimation device 1 of the first embodiment, a general ToF camera with a high degree of difficulty in change or improvement is not provided as the camera device 1A, and the ToF camera in the related art can be used as the camera device 1A that measures the distance values d between the camera device 1A and the object S. In other words, in the estimation device 1 of the first embodiment, since the same processing as the processing of setting the parameters, which is performed with respect to the ToF camera in the related art is performed (switched) a plurality of times as processing of setting the control conditions using the controller 40, the necessary functions of the camera device 1A can be realized. Accordingly, in the estimation device 1 of the first embodiment, it is possible to estimate the characteristics of the object S by performing measurement through an easy way.

Further, in the estimation device 1 of the first embodiment, the case in which the estimator 50 estimates the estimation distance D between the camera device 1A and the object S as the characteristics of the object S has been described. However, as described above, the estimator 50 can estimate, for example, the material of the object S (the estimation material M) or the attributes of the object S (the estimation attributes A), in addition to the estimation distance D of the object S. However, the processing of the estimation in the estimator 50 in this case can also be considered in the same manner as the processing of estimating the estimation distance D described above. Accordingly, detailed description related to the estimation processing other than the estimation distance D in the estimator 50 will be omitted.

### (Variant of First Embodiment)

Further, in the estimation device 1 of the first embodiment, the case in which the table which is created before practical use of the estimation device 1 is stored as the characteristics data stored in the storage 60 has been described. However, the characteristics data stored in the storage 60 are not limited to the above-mentioned table. For example, a network structure or a parameter of a trained model learned using a machine learning technology such as a neural network, a deep neural network, a convolutional neural network, or the like, may be stored in the storage 60. The trained model is, for example, a model mechanically learned such that the controller 40 outputs the characteristics of the object S represented by the input distance values d as a result when the information of the control conditions set on the light source 10 and the light receiver 20 and the distance values d represented by the object data output by the calculator 30 are input. A result of the characteristics of the object S output by the trained model is, for example, the distance values d corrected to reduce a difference between the distance values d, or the material, color, or the like, of the object S.

The trained model is also created by actually measuring the object assumed as the object S through the same method when the table is created (see FIG. 3). Here, the information of the control conditions and the distance values d are input as input data on an input side of the mechanical learning model, information such as the distance (the distance Dp) between the estimation device 1 and the measurement object SO, and the material, color, or the like, of the measurement object SO is input as training data on an output side of the mechanical learning model, and the trained model is created by learning the mechanical learning model. In this case, the estimator 50 inputs the information of the control conditions output by the controller 40 and the distance values d output by the calculator 30 into the trained model, obtains a result in which the trained model estimates the characteristics of the object S represented by the distance values d, and outputs the result as the estimation data.

In addition, for example, a table or a trained model including information representing the attributes of the object S and configured to estimate the attributes of the object S may be stored in the storage 60 as the attributes of the object S estimated on the basis of the distance values d represented by the object data output by the calculator 30. The attributes of the object S are, for example, information representing at least one of a reflection factor, a refractive index, a transmission factor, an attenuation coefficient, an absorption coefficient, a scattering cross-sectional area, a dielectric constant, a density, and a concentration of the object S. Even in this case, the estimator 50 outputs the estimated attributes of the object S as the estimation data through the same processing as the processing when the above-mentioned estimation distance D is estimated.

As described above, the estimation device 1 includes the controller 40 configured to switch a plurality of control conditions which are set so that there is satisfied at least one of conditions that the irradiation patterns of the irradiation light IL radiated to the object S differ from each other under the plurality of control conditions and that the light receiving patterns that receive the reflected light RL obtained by reflecting the irradiation light IL by the object S differ from each other under the plurality of control conditions, and the estimator 50 configured to estimate the characteristics of the object S on the basis of the object data related to the object acquired by receiving light through one or more light receiving gates G under the plurality of control conditions.

In addition, as described above, in the estimation device 1, the irradiation patterns are set so that there is satisfied at least one of conditions that the pulse lengths Ti differ from each other and that the signal level Ls of the irradiation pulse of the irradiation light IL differ from each other, and the light receiving patterns are set so that there is satisfied at least one of conditions that the pulse lengths Tg of gate pulse that determines a time response related to sensitivity when the light receiving gate G receives the reflected light RL differ from each other and that the relative time difference Td from the start time of the irradiation pulse to the start time of gate pulse differ from each other.

In addition, as described above, the estimation device 1 further includes the storage 60 configured to store the characteristics data that determines correspondence between the plurality of control conditions and the characteristics of the object S, and the estimator 50 may estimate the characteristics of the object S represented by the acquired object data on the basis of the characteristics data selected on the basis of the control conditions used when the object data is acquired.

In addition, as described above, in the estimation device 1, the estimator 50 may estimate the weighted sum of two or more characteristics of the object S corresponding to the characteristics data as the characteristics of the object S represented by the object data according to the weighting factor on the basis of the similarity between the characteristics of the object S represented by the acquired object data and the characteristics of the object S corresponding to the selected characteristics data.

In addition, as described above, in the estimation device 1, the characteristics data may be data representing a part or all of the reflected light RL received through the light receiving gate G, or the result obtained by performing four arithmetic operations on the multi-dimensional vector using two or more data as elements.

In addition, as described above, in the estimation device 1, the characteristics data may be a feature value constituted by at least one element obtained by further converting the multi-dimensional vector.

In addition, as described above, in the estimation device 1, the estimator 50 may further include the storage 60 configured to store a neural network that estimates the characteristics of the object S on the basis of the plurality of control conditions, and the estimator 50 may input the object data and the control conditions used when the object data are acquired to the neural network and estimate the characteristics of the object S represented by the acquired object data.

In addition, as described above, in the estimation device 1, the characteristics of the object S may include the distance between the camera device 1A and the object S.

In addition, as described above, in the estimation device 1, the characteristics of the object S may include the material of the object S.

In addition, as described above, in the estimation device 1, the characteristics of the object S may include information representing the attributes of the object S.

In addition, as described above, in the estimation device 1, the information representing the attributes of the object S may be information representing at least one of a reflection factor, a refractive index, a transmission factor, an attenuation coefficient, an absorption coefficient, a scattering cross-sectional area, a dielectric constant, a density, and a concentration of the object S.

In addition, the estimation device 1 may be a device including a storage device such as a ROM, a RAM, an HDD, a flash memory, or the like, realized by a processor such as a CPU, a GPU, or the like, hardware such as LSI, ASIC, FPGA, or the like, dedicated LST, or the like, and executing an estimation method of outputting the object data related to the object S acquired by receiving the reflected light RL obtained by reflecting the irradiation light IL radiated from the light source 10 on the object S through one or more light receiving gates G using the processor, switching the plurality of control conditions which are set so that there is satisfied at least one of conditions that the irradiation patterns of the irradiation light IL differ from each other under the plurality of control conditions and that the light receiving patterns of the reflected light RL differ from each other under the plurality of control conditions, and estimating the characteristics of the object S on the basis of the object data acquired under the plurality of control conditions.

In addition, the estimation device 1 may be a device including a storage device such as a ROM, a RAM, an HDD, a flash memory, or the like, realized by a processor such as a CPU, a GPU, or the like, hardware such as LSI, ASIC, FPGA, or the like, dedicated LSI, or the like, and in which a program of causing the processor to output the object data related to the object S acquired by receiving the reflected light RL obtained by reflecting the irradiation light IL radiated from the light source 10 on the object S through one or more light receiving gates G using the processor, switch the plurality of control conditions which are set so that there is satisfied at least one of conditions that the irradiation patterns of the irradiation light IL differ from each other and the light receiving pattern of the reflected light RL differ from each other, and estimate the characteristics of the object S on the basis of the object data acquired under the plurality of control conditions is stored.

### Second Embodiment

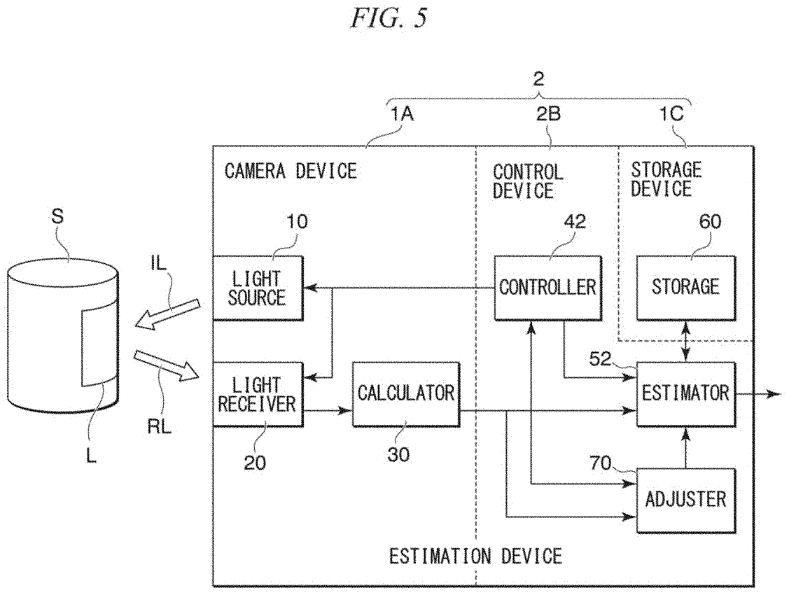

Hereinafter, an estimation device of a second embodiment will be described. FIG. 5 is a block diagram showing an example of a configuration of the estimation device of the second embodiment. An estimation device 2 includes, for example, the light source 10, the light receiver 20, the calculator 30, a controller 42, an estimator 52, the storage 60 and an adjuster 70.

In the estimation device 2, the adjuster 70 is added to the estimation device 1 of the first embodiment shown in FIG. 1. Then, in the estimation device 2, the adjuster 70 is added to the control device 1B included in the estimation device 1 to configure a control device 2B. For this reason, in the estimation device 2, the controller 40 included in the estimation device 1 is replaced with the controller 42, and the estimator 50 is replaced with the estimator 52. Other components included in the estimation device 2 are the same components as the components included in the estimation device 1 of the first embodiment. Accordingly, in the following description, in the components included in the estimation device 2, the same reference numerals are designated to the same components as the components of the estimation device 1 of the first embodiment, and detailed description related to these components will be omitted.

Like the control device 1B included in the estimation device 1, the control device 2B also controls an irradiation timing of the irradiation light IL by the light source 10 included in the camera device 1A and a light reception timing of the reflected light RL in the light receiving gates G included in the light receiver 20, and estimates the characteristics of the object S on the basis of the object data (the distance values d) output by the calculator 30.

Like the controller 40 included in the estimation device 1, the controller 42 sets setting of the control conditions on the light source 10 and the light receiver 20 when the characteristics of the object S are estimated in the estimation device 2. In addition, the controller 42 also outputs the information on the set control conditions (combinations of the irradiation patterns and the light receiving patterns) to the adjuster 70.

The adjuster 70 determines temporal or spatial fluctuation of the object data, i.e., a fluctuation of the distance values d on the basis of the distance values d represented by the object data output by the calculator 30. Here, the adjuster 70 may refer the information of the control conditions output by the controller 42. The adjuster 70 adjusts at least one condition of the number of times of changing the control conditions set on the light source 10 and the light receiver 20 by the controller 42 according to the fluctuation of the determined object data, the number of pieces of the characteristics data (table) obtained and referred from the storage 60 to estimate the characteristics of the object S using the estimator 52, and the category-weighting factor.

For example, when the temporal fluctuation of the object data is large, the adjuster 70 adjusts the controller 42 to increase the number of times to change the control conditions (the number of “n” in the above-mentioned equation (4) to the above-mentioned equation (6)). In this case, in the controller 42, when the number of times of setting the control conditions in practical use of the estimation device 1 is smaller than that when the characteristics data (table) are created and when the adjuster 70 is adjusted to increase the number of times of changing the control conditions, the number of times of setting the control conditions may be the same number as that when the characteristics data (table) are created. In addition, for example, when the temporal fluctuation of the object data is large, the adjuster 70 may adjust the controller 42 to increase the number of times of the distance values d measured under one control condition that is set. In addition, for example, when the temporal fluctuation of the object data is small, the adjuster 70 may adjust to terminate measurement of the distance values d with respect to the object S at this time. In addition, for example, when the temporal fluctuation of the object data is small, the adjuster 70 may adjust the controller 42 to terminate the measurement of the distance values d under one control condition that is set and adjust to start measurement under the next control condition. Here, the adjuster 70 may designate a condition to be changed on the basis of the information of the control conditions output by the controller 42.

Like the estimator 50 included in the estimation device 1, the estimator 52 estimates the characteristics of the object S on the basis of the information of the control conditions output by the controller 42 and the distance values d represented by the object data output by the calculator 30. Here, the estimator 52 estimates the characteristics data (table) of the number adjusted by the adjuster 70 or the characteristics of the object S at a category-weighting factor. The estimator 52 also outputs the estimated characteristics (the estimation distance D, the estimation material M, the estimation attributes A) of the object S as the estimation data.

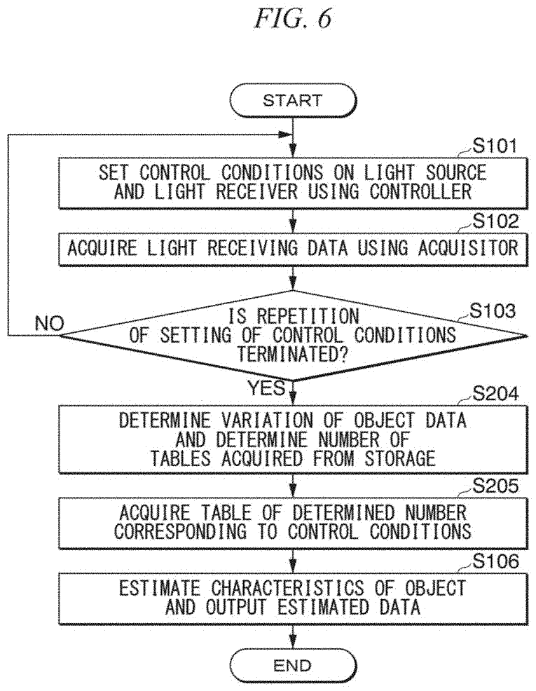

Next, an operation in practical use of the estimation device 2 will be described. FIG. 6 is a flowchart showing a flow of an estimation operation in the estimation device 2 of the second embodiment. Further, even in the following description, the table used to estimate the characteristics of the object S by the estimator 52 is already stored in the storage 60. When the estimation device 2 is practically used, the controller 42 sets (i.e., repeats the same number of times) the same control conditions as those when the characteristics data (table) are created on the camera device 1A, and the estimator 52 estimates the characteristics of the object S on the basis of the object data output by the calculator 30 with reference to the characteristics data (table) adjusted by the adjuster 70. Even in the following description, the controller 42 switches the control conditions set on the camera device 1A n times, and the calculator 30 outputs the multi-dimensional vector in the same form as the multi-dimensional vector v_{d} represented by the above-mentioned equation (7) to the estimator 52 and the adjuster 70 as the object data. In addition, in the following description, the adjuster 70 adjusts the number of pieces of the characteristics data (table) acquired from the storage 60 to cause the estimator 52 to estimate the characteristics of the object S.

Further, the flowchart showing the flow of the operation of the estimation device 2 shown in FIG. 6 includes the same operation (processing) as the flowchart showing the flow of the operation of the estimation device 1 of the first embodiment. Accordingly, in the following description, in the flowchart showing the flow of the operation of the estimation device 2, the same step numbers are designated to the same operation (processing) as the flowchart showing the flow of the operation of the estimation device 1, and the explanation focuses on different operations (processing).

When the estimation device 2 starts the operation of estimating the characteristics of the object S, the controller 42 sets the control conditions on the light source 10 and the light receiver 20 included in the camera device 1A (step S101). Accordingly, the light source 10 radiates the irradiation light IL to the object S, and the light receiver 20 outputs the light reception data representing the quantity of the reflected light RL received through the light receiving gate G to the calculator 30. Then, the calculator 30 acquires the light reception data output by the light receiver 20 (step S102), and obtains the object data (the distance values d) on the basis of the light reception data acquired.

The controller 42 terminates change (switching) of the control conditions when repetition of the set control conditions is terminated n times (“YES” in step S103), and the calculator 30 outputs the multi-dimensional vector including n times of object data obtained in the control conditions to the estimator 52 and the adjuster 70 as the object data of the object S.

Next, the adjuster 70 determines a variation of the distance values d of the control conditions represented by object data (the multi-dimensional vector) output by the calculator 30. Then, the adjuster 70 determines the number of tables acquired from the storage 60 to estimate the characteristics of the object S using the estimator 52 on the basis of the determined variation of the distance values d (step S204). The adjuster 70 outputs the determined number of tables to the estimator 52.

Next, the estimator 52 selects the corresponding table stored in the storage 60 on the basis of the information of the control conditions output by the controller 42, and acquires the number of tables output by the adjuster 70 (step S205). Then, the estimator 52 compares the data represented in the table acquired from the storage 60 with the distance values d of the control conditions represented by the object data (the multi-dimensional vector) output by the calculator 30, and estimates the characteristics of the object S. The estimator 52 outputs the estimation data of the estimated characteristics of the object S (step S106).

As described above, even in the estimation device 2 of the second embodiment, like the estimation device 1 of the first embodiment, the controller 42 changes (switches) the control conditions (the irradiation patterns and the light receiving patterns) a plurality of times when the light source 10 and the light receiver 20 included in the camera device 1A are operated. Then, in the estimation device 2 of the second embodiment, the adjuster 70 determines a variation of the object data output by the calculator 30 included in the camera device 1A, and the controller 42 adjusts the number of times of changing the control conditions set on the camera device 1A, the number of pieces of the characteristics data (tables) acquired from the storage 60 to estimate the characteristics of the object S using the estimator 52, the category-weighting factor, and the like. After that, even in the estimation device 2 of the second embodiment, like the estimation device 1 of the first embodiment, the estimator 52 refers the table acquired from the storage 60, and estimates the characteristics of the target object S on the basis of the object data output by the calculator 30 included in the camera device 1A. Accordingly, even in the estimation device 2 of the second embodiment, like the estimation device 1 of the first embodiment, a highly accurate measured result (or corrected result) can be obtained with regard to the estimation of the characteristics of the target object S using a simple measurement method. Further, in the estimation device 2 of the second embodiment, by determining the variation of the object data, for example, it is possible to obtain the measured result (or the corrected result) having high tolerance (robustness) with respect to the disturbance such as the fluctuation of the environment (fluctuation of environmental light) in which the characteristics of the object S are measured or the like.

Further, in the estimation device 2 of the second embodiment, the case in which the adjuster 70 adjusts the number of pieces of characteristics data (tables) acquired from the storage 60 to estimate the characteristics of the object S using the estimator 52 has been described. However, as described above, the adjuster 70 can also adjust the number of times of changing the control conditions set by the controller 42, the category-weighting factor when the estimator 52 estimates the characteristics of the object S, or the like. However, processing of adjustment in the adjuster 70 in this case can be considered in the same manner as the processing of adjusting the number of pieces of characteristics data (tables) described above. Accordingly, detailed description related to adjustment processing of the number of pieces of the characteristics data (tables) in the adjuster 70 will be omitted. In addition, like the estimation device 1 of the first embodiment, detailed description of the estimation processing other than the estimation distance D in the estimator 52 will also be omitted.

As described above, the estimation device 2 may further include the adjuster 70 configured to adjust the number of pieces of the object data used when the estimator 50 estimates the characteristics of the object S according to the temporal or spatial variation in the object data.

In addition, as described above, the estimation device 2 may further include the adjuster 70 configured to adjust the number of pieces of the characteristics data selected by the estimator 50 or the weighting factor according to the temporal or spatial variation in the object data.

### Third Embodiment

Hereinafter, an estimation device of a third embodiment will be described. In the estimation device 1 of the first embodiment and the estimation device 2 of the second embodiment, use of the estimation data output by the estimator 50 or the estimator 52 has not been described in detail. In the estimation device of the third embodiment, an example of use of the estimation data output by the estimator 50 will be described. In the following description, the case in which the light receiver 20 is a distance image sensor in which a plurality of pixels configured to receive the reflected light RL to measure the distance are disposed in a two-dimensional matrix form, and a feature image representing the characteristics of the object S as an image is generated using the estimation data on the basis of the light reception data output by the pixels will be described.

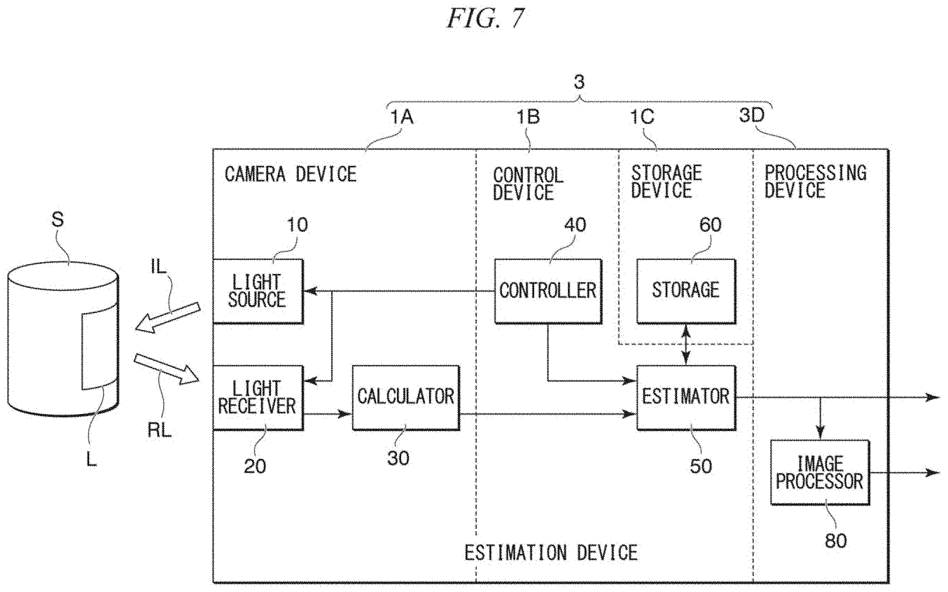

FIG. 7 is a block diagram showing an example of a configuration of the estimation device of the third embodiment. An estimation device 3 includes, for example, a light source 10, a light receiver 20, a calculator 30, a controller 40, an estimator 50, a storage 60, and an image processor 80.

In the estimation device 3, the image processor 80 is added to the estimation device 1 of the first embodiment shown in FIG. 1. Then, in the estimation device 3, the image processor 80 is distributedly disposed and configured as a processing device 3D. Other components included in the estimation device 3 are the same components as the components included in the estimation device 1 of the first embodiment. Accordingly, in the following description, in the components included in the estimation device 3, the same components as the components of the estimation device 1 of the first embodiment are designated by the same reference numerals, and detailed description related to the components will be omitted.

The image processor 80 included in the processing device 3D performs predetermined image processing on the estimation data output by the estimator 50 and generates a feature image. In addition, the image processor 80 generates another feature image by performing further filtering on the generated feature image. For example, when the estimation distance D obtained by estimating the distance between the camera device 1A and the object S and the estimation material M obtained by estimating the material of the object S are included in the estimation data output by the estimator 50, the image processor 80 generates an feature image by performing filtering on the image generated on the basis of the estimation distance D and the estimation material M. More specifically, the image processor 80 generates a feature image (hereinafter, referred to as a “distance image”) representing the distance between the camera device 1A and the object S on the basis of the estimation distance D included in the estimation data. In addition, the image processor 80 generates a feature image (hereinafter, referred to as a “material image”) representing the material of the object S on the basis of the estimation material M included in the estimation data. Further, the image processor 80 generates a feature image by performing filtering on the generated distance image and material image. The image processor 80 outputs the generated feature image. Further, the image processor 80 may output another feature image (here, a distance image or a material image) generated in a process of generating a final feature image.

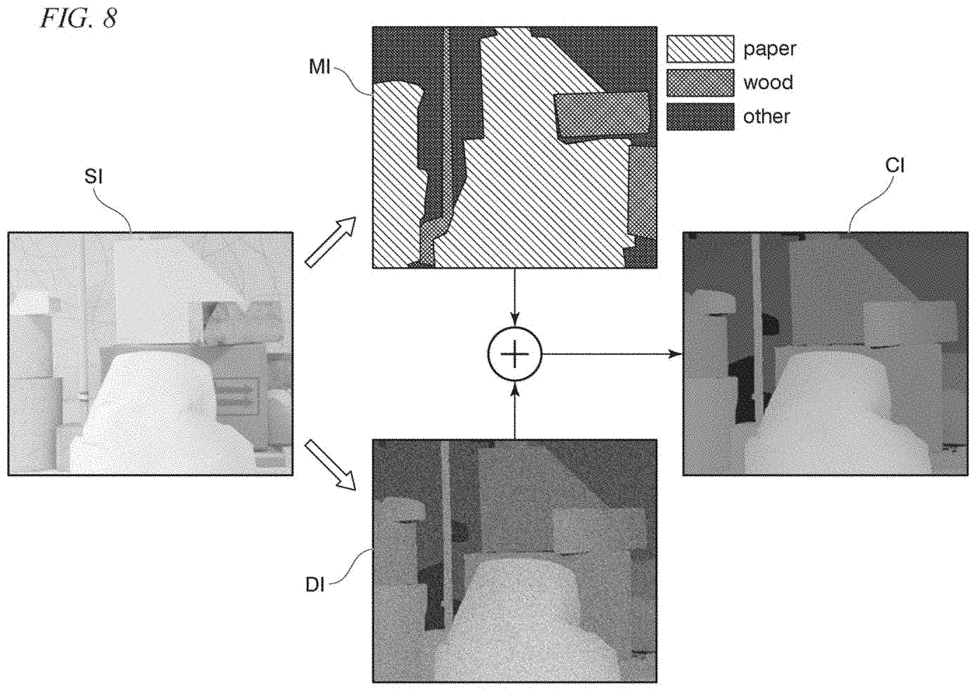

Here, an example of image processing (filtering) of generating a feature image representing a distance and a material of the object S using the image processor 80 will be described. FIG. 8 is a view showing an example of image processing of generating a feature image in the image processor 80. FIG. 8 shows an example of an image (hereinafter, referred to as an “object image”) SI of the object S under an environment imaged by the camera device 1A, i.e., in which the light receiver 20 receives the reflected light RL. In addition, FIG. 8 shows an example of a distance image DI generated on the basis of the estimation distance D included in the estimation data output by the estimator 50 and a material image MI generated on the basis of the estimation material M included in the estimation data using the image processor 80. Further, FIG. 8 shows an example of a feature image CI generated by performing filtering on the distance image DI and the material image MI using the image processor 80.

The image processor 80 generates the distance image DI included in the estimation data and obtained by performing image processing of disposing the estimation distance D of the position of each pixel included in the light receiver 20 on a corresponding position within the range of the image. Similarly, the image processor 80 generates the material image MI by performing image processing of disposing each estimation material M included in the estimation data on a corresponding position within the range of the image. After that, the image processor 80 generates the feature image CI by performing filtering on the distance image DI using the generated material image MI as a reference image.

The filtering performed by the image processor 80 is smoothing filtering on the basis of a principle of, for example, a bilateral filter, a guided filter, a non-local means filter, or the like.

When the filtering performed by the image processor 80 is filtering on the basis of, for example, the bilateral filter, the filtering is performed by a calculation formula shown in the following equation (15) and the following equation (16).

$$\begin{matrix}[ Math . 15 ] & \\ \hat{I} ( p ) = \frac{1}{{\sum }_{{q}^{′} ∈ S ( p )} w ( p , {q}^{′} )} {\sum }_{q ∈ S ( p )} w ( p , q ) I ( q ) & ( 15 ) \\ [ Math . 16 ] & \\ w ( p , q ) = exp ( \frac{{‖ p - q ‖}_{2}^{2}}{- 2 {σ}_{s}^{2}} ) exp ( \frac{{‖ A ( p ) - A ( q ) ‖}_{2}^{2}}{- 2 {σ}_{r}^{2}} ) & ( 16 )\end{matrix}$$

In the above-mentioned equation (15) and the above-mentioned equation (16), \hat{ }I means the distance image DI after filtering is performed, I means the distance image DI before filtering is performed, p means an attention pixel in the distance image DI, q means a reference pixel in the distance image DI, w (p, q) means a weighting function of filtering, S(p) means a set of reference pixels around the attention pixel, A means the material image MI (the reference image), σₛ means a smoothing coefficient in a space direction in the material image MI, and σᵣ means a smoothing coefficient in a material represented by the material image MI.

Accordingly, “A(p)-A(q)” of a second term on a right side in the above-mentioned equation (16) is a binary value that represent whether the materials of the attention pixel p in the distance image DI and the reference pixel q in the distance image DI are the same material.

The image processor 80 generates the feature image CI by performing smoothing filtering such as filtering based on the above-mentioned bilateral filter.

Further, the image processor 80 may generate a feature image (hereinafter, referred to as a “attribute image”) representing the attributes of the object S on the basis of the estimation attributes A included in the estimation data output by the estimator 50. Then, the image processor 80 may also generate a feature image by performing filtering on the attribute image generated as the distance image DI. In this case, “A(p)-A(q)” of a second term on a right side in the above-mentioned equation (16) is a continuous value that represent a difference in attribute values of the attention pixel p in the distance image DI and the reference pixel q in the distance image DI.

As described above, even in the estimation device 3 of the third embodiment, like the estimation device 1 of the first embodiment, the controller 40 changes (switches) the control conditions (the irradiation patterns and the light receiving patterns) a plurality of times when the light source 10 and the light receiver 20 included in the camera device 1A are operated. Then, even in the estimation device 3 of the third embodiment, like the estimation device 1 of the first embodiment, the estimator 50 refers the table acquired from the storage 60, and estimates the characteristics of the target object S on the basis of the object data output by the calculator 30 included in the camera device 1A. After that, in the estimation device 3 of the third embodiment, the image processor 80 generates the feature image CI that represent the characteristics of the object S estimated by the estimator 50 as an image. Accordingly, even in the estimation device 3 of the third embodiment, like the estimation device 1 of the first embodiment, it is possible to obtain a highly accurate measured result (or corrected result) in regard to the estimation of the characteristics of the target object S using an easy measurement method. Further, in the estimation device 3 of the third embodiment, since the feature image (may be a distance image, a material image, an attribute image, or the like) is generated and output based on the estimation data, the characteristics of the object S can be visually represented, and ease of confirmation can be improved.

Further, in the estimation device 3 of the third embodiment, the case in which the image processor 80 generates the feature image through the filtering based on the bilateral filter has been described. However, as described above, the filtering in the image processor 80 includes filtering other than the bilateral filter. However, the filtering in the image processor 80 in this case can be easily understood on the basis of the filtering method based on the above-mentioned bilateral filter and a principle of each filtering. Accordingly, detailed description related to processing of generating a feature image by another filtering in the image processor 80 will be omitted.

As described above, the estimation device 3 may further include the image processor 80 configured to generate a feature image of the object S on the basis of the characteristics of the object S corresponding to each of the light receiving gates G, and perform filtering based on at least one of the material of the object S and the attributes of the object S with respect to the generated feature image.

As described above, in the estimation device of each embodiment, before practical use of the estimation device is started, the characteristics data are created using a measurement object assumed as a target object, of which characteristics are estimated. Here, in the estimation device of each embodiment, the controller changes (switches) the control conditions (the irradiation patterns and the light receiving patterns) a plurality of times when the light source and the light receiver are operated, and creates the characteristics data. After that, in the estimation device of each embodiment, during the practical use of the estimation device 1, the controller sets the same control conditions on the light source and the light receiver when the characteristics data are created (repeats the same number of times), and the estimator estimates the characteristics of the target object. Accordingly, in the estimation device of each embodiment, the characteristics of the target object can be more accurately estimated.

### (Application Example of Estimation Device)

Hereinafter, an application example of the estimation device of the embodiment will be described. The estimation device can be widely applied to an object conveyance system for distribution (for example, a handling system (a picking system) for distribution) in a distribution warehouse configured to automatically perform loading and unloading of luggage, an industrial robot system, and other systems. In the following description, an example of the case in which the estimation device 1 of the first embodiment is applied to the object conveyance system for distribution will be described.

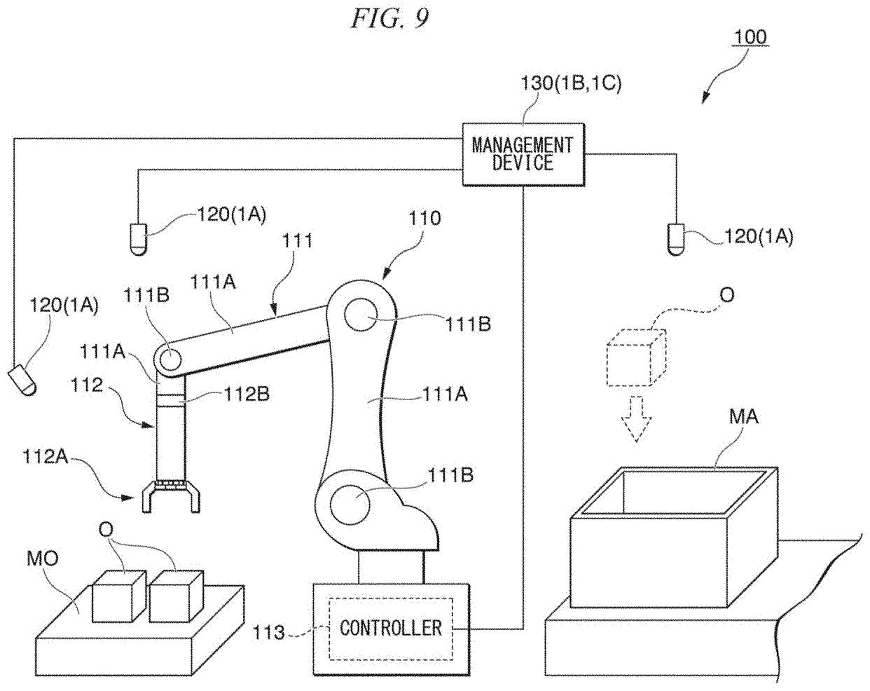

FIG. 9 is a view schematically showing an example of a configuration of an object conveyance system that employs the estimation device 1. An object conveyance system 100 includes, for example, a handling device 110, one or more object detectors 120 and a management device 130. The handling device 110 includes, for example, a moving mechanism 111, a holder 112 and a controller 113. The moving mechanism 111 includes, for example, a plurality of arms 111A, and a plurality of pivots 111B configured to pivotably connect the plurality of arms 111A. The holder 112 includes, for example, a tip 112A and a pivot 112B.

In the object conveyance system 100, a conveyance target object O disposed in a source category MO is moved to a destination category MA. Further, the object conveyance system 100 also includes a device or a system configured to perform conveyance (movement) of an object as a product assembly or a part of another purpose.

The source category MO is a place where the conveyance target object O is disposed. The source category MO is, for example, various types of conveyors, various types of pallets, or a container such as a tote, a bin, an oricon, or the like. Further, the source category MO is not limited thereto. Various types of conveyance target objects O having different sizes, weights, shapes and materials are randomly disposed in the source category MO. The conveyance target object O has various sizes, for example, from a small one such as a 5 [cm] square to a large one such as a 30 [cm] square. In addition, the conveyance target object O has various weights, for example, from a light one such as tens [g] to a heavy one such as several [kg]. In addition, the conveyance target object O has various shapes such as a polygonal shape, a tubular shape, a circular shape, or the like. In addition, the conveyance target object O includes various materials such as a paper such as a corrugated board or the like, plastic, vinyl, a metal, fabric, or the like. Further, the conveyance target object O may use a plurality of materials such as a vinyl label adhered to a corrugated board box, or the like. Further, the sizes, weights, shapes and materials of the conveyance target object O are not limited thereto.

The destination category MA is a place of a conveyance destination of the conveyance target object O. The destination category MA is a container such as a tote or an oricon. The “container” widely means a member that can accommodate the conveyance target object O (for example, a box-shaped member). Further, the destination category MA is not limited to the container. Accordingly, the object conveyance system 100 and the handling device 110 may move the conveyance target object O to the destination category MA other than the container.

The handling device 110 is, for example, a robot device. The handling device 110 holds the conveyance target object O disposed in the source category MO, and moves the held conveyance target object O to the destination category MA. Here, the handling device 110 performs communication with the management device 130 through wired communication or wireless communication, and moves the conveyance target object O designated by the management device 130 to the destination category MA from the source category MO designated by the management device 130.

The moving mechanism 111 is a mechanism configured to move the holder 112 to a desired position. The moving mechanism 111 is, for example, a 6-axis vertical articulated robot arm. Further, the moving mechanism 111 is not limited to the configuration. The moving mechanism 111 may be, for example, a 3-axis orthogonal robot arm, or may be a mechanism configured to move the holder 112 to a desired position using another configuration. In addition, the moving mechanism 111 may include a sensor or the like configured to detect a joint angle of each joint (for example, a rotation angle or the like of the pivot 111B). In addition, the moving mechanism 111 may be, for example, a flight vehicle (for example, a drone) or the like configured to lift and move the holder 112 using the rotor.

The holder 112 is a holding mechanism configured to hold the conveyance target object O disposed in the source category MO on the tip 112A. The holder 112 is connected to the moving mechanism 111 via the pivot 112B. The tip 112A is a mechanism configured to clamp the conveyance target object O using a plurality of clamp members. Further, the tip 112A is not limited to the mechanism configured to clamp the conveyance target object O. The tip 112A may be, for example, a mechanism including an absorber and a suction device in communication with the absorber and configured to hold the conveyance target object O through adsorption. In addition, the tip 112A may be a mechanism configured to hold the conveyance target object O using another mechanism. In addition, for example, the holder 112 or the tip 112A may be configured to be automatically replaceable according to an instruction from the controller 113 or the management device 130.

The controller 113 controls all operations of the handling device 110. The controller 113 clamps (holds) the conveyance target object O on the tip 112A by controlling the arms 111A or the pivots 111B included in the moving mechanism 111 and the tip 112A or the pivot 112B included in the holder 112 according to control from the management device 130.

The object detector 120 is a camera or various sensors disposed adjacent to the source category MO (for example, immediately above or obliquely above the source category MO) or adjacent to the destination category MA (for example, immediately above or obliquely above the destination category MA). The object detector 120 includes the camera device 1A of the estimation device 1. In this case, the object detector 120 (the camera device 1A) outputs the object data obtained by measuring the conveyance target object O to the management device 130. Further, the camera device 1A may be provided at a position of a part of the handling device 110 that can measure the conveyance target object O, for example, the arms 111A of the handling device 110, the tip 112A of the holder 112, or the like. In this case, the camera device 1A may output the object data obtained by measuring the conveyance target object O to the controller 113 or may output the object data to the management device 130 via the controller 113.

The management device 130 performs management and control of the object conveyance system 100 as a whole. The management device 130 acquires the information detected by the object detector 120, controls the handling device 110 on the basis of the acquired information, and conveys (moves) the conveyance target object O from the source category MO to the destination category MA. The management device 130 includes the control device 1B and the storage device 1C of the estimation device 1. The management device 130 estimates the distance between the tip 112A and the conveyance target object O and the material thereof on the basis of the object data output by the object detector 120 (the camera device 1A). Then, the management device 130 controls clamping (holding) of the conveyance target object O by the tip 112A according to the estimated material of the conveyance target object O.

For example, when the conveyance target object O is a corrugated board box or a plastic container, the management device 130 controls the tip 112A to clamp or adsorb the conveyance target object O. Here, in the management device 130, when the tip 112A is controlled to clamp the conveyance target object O, for example, ability when the corrugated board box is clamped may be controlled to be lower than ability when the plastic container is clamped. In addition, for example, when the vinyl label is adhered to the corrugated board box that is the conveyance target object O, the management device 130 controls the tip 112A such that the conveyance target object O is clamped without adsorbing the conveyance target object O. Accordingly, it is possible to prevent the vinyl label adhered to the corrugated board box from being peeled off by adsorption. Further, when the tip 112A of the current holder 112 connected to the moving mechanism 111 is a mechanism configured to hold the conveyance target object O through adsorption, the management device 130 may be controlled to be exchanged for the holder 112 including the tip 112A of the mechanism configured to clamp the conveyance target object O.

Further, when the camera device 1A is installed at a position of a portion of the handling device 110, the control device 1B of the estimation device 1 may include, for example, the controller 113. In this case, the control device 1B included in the controller 113 estimates the distance between the tip 112A and the conveyance target object O and the material thereof on the basis of the object data output by the camera device 1A. Further, here, the storage device 1C of the estimation device 1 may be provided any one of, for example, the management device 130, the controller 113, or other devices, as long as the control device 1B can refer the table. Then, the controller 113 outputs the estimated data to the management device 130, and clamps (holds) the conveyance target object O on the tip 112A according to the control from the management device 130.

In this way, when the estimation device 1 is applied to the object conveyance system 100, it is possible to perform the control when the conveyance target object O is clamped (held) on the tip 112A according to the material of the conveyance target object O. Accordingly, in the object conveyance system 100, the conveyance target object O can be more carefully handled.

Further, in the application example of the estimation device, the case in which the estimation device 1 is applied to the object conveyance system for distribution will be described. However, as described above, the estimation device of the embodiment can be applied to another system, and however, a method of using disposition of the estimation device when the estimation device of the embodiment is used as the other system or estimation data estimated by the estimation device can be easily understood using the same consideration method as the case in which the estimation device is applied to the above-mentioned object conveyance system for distribution. Accordingly, detailed description related to the case in which the estimation device of the embodiment is used as another system will be omitted.

As described above, the object conveyance system 100 may include, for example, the estimation device 1, and the holding mechanism (for example, the handling device 110, the holder 112, or the like) configured to hold the object recognized on the basis of the characteristics of the object S estimated by the estimation device 1 (for example, the conveyance target object O) and move the conveyance target object O to a predetermined position (for example, the destination category MA).

As described above, in the conveyance system to which the estimation device of each embodiment is applied, at least the camera device included in the estimation device (in the application example of the above-mentioned estimation device, the object detector) is disposed at a position where the target object to be estimated can be measured. Then, in the conveyance system to which the estimation device of each embodiment is applied, the control device included in the estimation device refers the characteristics data stored in the storage device, and estimates the characteristics of the target object on the basis of the object data output by the camera device. Accordingly, in the conveyance system to which the estimation device of each embodiment is applied, it is possible to estimate the characteristics of the target object with high accuracy and control and convey the object according to a conveyance method suitable for the characteristics of the object.

According to at least one embodiment as described above, characteristics of an object (S) can be estimated by performing measurement through a simple method by providing a controller (40) configured to switch a plurality of control conditions which are set so that there is satisfied at least one of conditions that irradiation patterns of irradiation light (IL) radiated to the object (S) differ from each other under the plurality of control conditions and a light receiving pattern to receive reflected light (RL) obtained by reflecting the irradiation light (IL) by the object (S) differ from each under the plurality of control conditions, and an estimator (50) configured to estimate the characteristics of the object (S) on the basis of the object data (for example, the distance values d) related to the object (S) acquired by receiving light from one or more light receiving gates (G) under the plurality of control conditions.

While preferred embodiments of the invention have been described, these embodiments are presented as examples and are not intended to limit the scope of the present invention. These embodiments can be implemented in various embodiments and various omissions, replacements and changes may be made without departing from the spirit of the present invention. These embodiments or variants thereof included in the present invention described in the claims and equivalents thereof as well as being included in the scope of the present invention.

1. An estimation device comprising:
a controller configured to switch a plurality of control conditions which are set so that there is satisfied at least one of conditions that that irradiation patterns of irradiation light radiated to an object are different from each other under the plurality of control conditions, and that light receiving patterns to receive reflected light obtained by reflecting the irradiation light by the object are different from each other under the plurality of control conditions; and
an estimator configured to estimate characteristics of the object on the basis of object data related to the object acquired by receiving light from one or more light receiving gates under the plurality of control conditions.

2. The estimation device according to claim 1, wherein the irradiation patterns are set so that there is satisfied at least one of conditions that pulse lengths differ from each other and that signal levels of irradiation pulses of the irradiation lights differ from each other, and
the light receiving patterns are set so that there is satisfied at least one of conditions that at least one of conditions that pulse lengths of gate pulses that determine a time response related to sensitivity when the light receiving gate receives the reflected light differ from each other and that relative time differences from a start time of the irradiation pulse to a start time of the gate pulse differ from each other.

3. The estimation device according to claim 1, further comprising:
a storage configured to store characteristics data to determine correspondence between the plurality of control conditions and the characteristics of the object,
wherein the estimator is configured to estimate the characteristics of the object that represent the acquired object data on the basis of the characteristics data selected on the basis of the plurality of control conditions which have been used when the object data are acquired.

4. The estimation device according to claim 3, wherein the estimator is configured to estimate a weighted sum by a weighting factor of two or more characteristics of the object corresponding to the characteristics data as the characteristics of the object represented by the object data on the basis of similarity between the characteristics of the object represented by the acquired object data and the characteristics of the object corresponding to the selected characteristics data.

5. The estimation device according to claim 3, wherein the characteristics data includes a result obtained by applying four arithmetic operations on data representing part or all of the reflected light received through the light receiving gate or on a multi-dimensional vector which element are two or more pieces of the data.

6. The estimation device according to claim 5, wherein the characteristics data includes a feature value constituted by at least one element obtained by further converting the multi-dimensional vector.

7. The estimation device according to claim 1, further comprising:
a storage configured to store a neural network configured to estimate characteristics of the object on the basis of the plurality of control conditions,
wherein the estimator is configured to input, into the neural network, the object data and the control conditions used when the object data was acquired, and to estimate the characteristics of the object represented by the acquired object data.

8. The estimation device according to claim 1, further comprising:
an adjuster configured to adjust the number of pieces of the object data used when the estimator estimates the characteristics of the object in accordance with a time variation or a spatial variation of the object data.

9. The estimation device according to claim 4, further comprising:
an adjuster configured to adjust the number of pieces of the characteristics data selected by the estimator or the weighting factor in accordance with a time variation or a spatial variation of the object data.

10. The estimation device according to claim 1, wherein the characteristics of the object comprise a distance from the object.

11. The estimation device according to claim 1, wherein the characteristics of the object comprise a material of the object.

12. The estimation device according to claim 1, wherein the characteristics of the object comprise information representing at least one attribute of the object.

13. The estimation device according to claim 12, wherein the information representing the at least one attribute of the object includes at least one of a reflection factor, a refractive index, a transmission factor, an attenuation coefficient, an absorption coefficient, a scattering cross-sectional area, a dielectric constant, a density, and a concentration of the object.

14. The estimation device according to claim 11, further comprising:
an image processor configured to generate an image of the characteristics of the object on the basis of the characteristics of the object corresponding to the light receiving gates and to perform filtering based on the material of the object with respect to the generated feature image.

15. The estimation device according to claim 12, further comprising:
an image processor configured to generate an image of the characteristics of the object on the basis of the characteristics of the object corresponding to the light receiving gates and to perform filtering based on the attributes of the object with respect to the generated feature image.

16. An object conveyance system comprising:
an estimation device comprising:
a controller configured to switch a plurality of control conditions which are set so that there is satisfied at least one of conditions that that irradiation patterns of irradiation light radiated to an object are different from each other under the plurality of control conditions, and that light receiving patterns to receive reflected light obtained by reflecting the irradiation light by the object are different from each other under the plurality of control conditions; and
an estimator configured to estimate characteristics of the object on the basis of object data related to the object acquired by receiving light from one or more light receiving gates under the plurality of control conditions; and
a holding mechanism configured to hold the object recognized on the basis of the characteristics of the object estimated by the estimation device and to move the object to a predetermined position.

17. An estimation method performed by a computer, the method comprising:
switching a plurality of control conditions which are set so that there is satisfied at least one of conditions that that irradiation patterns of irradiation light radiated to an object are different from each other under the plurality of control conditions, and that light receiving patterns to receive reflected light obtained by reflecting the irradiation light by the object are different from each other under the plurality of control conditions; and
estimating characteristics of the object on the basis of object data related to the object acquired by receiving light from one or more light receiving gates under the plurality of control conditions.

18. A non-transitory computer readable storage medium that stores computer-executable instructions, which when executed by one or more computers, cause the computer to perform:
switching a plurality of control conditions which are set so that there is satisfied at least one of conditions that that irradiation patterns of irradiation light radiated to an object are different from each other under the plurality of control conditions, and that light receiving patterns to receive reflected light obtained by reflecting the irradiation light by the object are different from each other under the plurality of control conditions; and
estimating characteristics of the object on the basis of object data related to the object acquired by receiving light from one or more light receiving gates under the plurality of control conditions.
